(19) United States
(12) Patent Application Publication
(10) Pub. No.: US 2008/0231350 A1
(43) Pub. Date: Sep. 25, 2008

(54) Internal voltage generating circuit for use in a semiconductor device

(76) Inventor: Sang-Joon Hwang, Seoul (KR)

Correspondence Address: LEE & MORSE, P.C., 3141 FAIRVIEW PARK DRIVE, SUITE 500, FALLS CHURCH, VA, 22042, US

(21) Appl. No.: 12/076,492

(22) Filed: Mar. 19, 2008

(30) Foreign Application Priority Data
Mar. 23, 2007 (KR) 10-2007-0028472

(51) Int. Cl. G05F 1/10

(52) U.S. Cl. 327/540

(57) ABSTRACT

An internal voltage generating circuit for use in a semiconductor memory device includes a reference voltage input terminal to receive a reference voltage, a comparison unit to output a first internal voltage, the first internal voltage having a voltage level based at least in part on the reference voltage, a first feedback unit to receive the first internal voltage and an external voltage and to provide a first feedback internal voltage to the comparison unit, a loading circuit to output a second internal voltage, and a second feedback unit to receive the second internal voltage from the loading circuit and to provide a second feedback internal voltage to the comparison unit.

### BACKGROUND OF THE INVENTION

1. Field of the Invention

Embodiments of the present invention relate to a semiconductor device. More particularly, embodiments of the present invention relate to an internal voltage generating circuit that may be utilized in a semiconductor device, and a method of operation thereof.

2. Description of the Related Art

As semiconductor memory devices become relatively highly integrated and operate at relatively high speeds, power consumption and reliability of the semiconductor memory devices become increasingly important. Typically, in semiconductor memory devices such as dynamic random access memory (DRAM) devices, an internal voltage generating circuit employs an external voltage in order to generate an internal voltage for use in the DRAM.

The conventional internal voltage generating circuit includes a single feedback input terminal to receive an internal voltage as a feedback. Thus, if a voltage level of an internal voltage changes by a relatively large amount, it may be difficult to stably supply an internal voltage. Furthermore, if the internal voltage is supplied to circuitry located at a distance from the internal voltage generating circuit, feedback characteristics are relatively lowered and the internal voltage generating circuit may not be able to immediately respond to the changed voltage level. Accordingly, there remains a need to address one or more of these limitations found in the conventional art.

### SUMMARY OF THE INVENTION

Embodiments of the present invention are therefore directed to an internal voltage generating circuit and a method of operation thereof.

It is therefore a feature of an embodiment of the present invention to provide an internal voltage generating circuit that may be employed to generate an internal voltage.

It is therefore a feature of another embodiment of the present invention to provide a method of generating an internal voltage in an internal voltage generating circuit.

At least one of the above and other features of the present invention may be realized by providing an internal voltage generating circuit, including a reference voltage input terminal to receive a reference voltage, a comparison unit to output a first internal voltage, the first internal voltage having a voltage level based at least in part on the reference voltage, a first feedback unit to receive the first internal voltage and an external voltage and to provide a first feedback internal voltage to the comparison unit, a loading circuit to output a second internal voltage, and a second feedback unit to receive the second internal voltage from the loading circuit and to provide a second feedback internal voltage to the comparison unit.

The comparison unit may be further adapted to generate another first internal voltage based at least in part on a comparison of the first feedback internal voltage and the second feedback internal voltage. Further, the comparison unit may be a current mirror type differential amplifier.

The first feedback internal voltage and the second feedback internal voltage may be provided to the comparison unit in parallel. The first feedback unit may include a driving unit to receive the external voltage, to drive the external voltage according to the first internal voltage provided from the comparison unit, and to provide a feedback to the feedback input terminal. Further, the first feedback internal voltage may have a voltage level higher than the second feedback internal voltage. The current mirror type differential amplifier may be configured to operate as a comparator.

At least one other of the above and other features of the present invention may be realized by providing an internal voltage generating circuit, including a reference voltage input terminal to receive a reference voltage, a comparison unit to output an internal voltage, the internal voltage having a voltage level based at least in part on the reference voltage, a first feedback unit to receive the internal voltage and an external voltage and to provide a first feedback internal voltage to the comparison unit, and a second feedback unit to receive the internal voltage and an external voltage and to provide a second feedback internal voltage to the comparison unit.

The comparison unit may be further adapted to generate another internal voltage based at least in part on a comparison of the first feedback internal voltage and the second feedback internal voltage. Further, the comparison unit may be a current mirror type differential amplifier.

The first feedback internal voltage and the second feedback internal voltage may be provided to the comparison unit in parallel. The first feedback unit and the second feedback unit may each include a driving unit to receive the external voltage, to drive the external voltage according to the internal voltage provided from the comparison unit, and to provide a feedback to the feedback input terminal. Further, the current mirror type differential amplifier may be configured to operate as a comparator.

At least one other of the above and other features of the present invention may be realized by providing a method of generating an internal voltage, including generating an internal voltage based at least in part on a reference voltage, providing the internal voltage to a feedback input unit and to a loading circuit, receiving a plurality of voltage feedback inputs based at least in part on the provided internal voltage, and adjusting the generated internal voltage based at least in part on the plurality of voltage feedback inputs.

The plurality of voltage feedback inputs may be received at approximately the same time. Further, the plurality of feedback inputs may include a first and a second feedback input provided from the feedback input unit and from the loading circuit, respectively.

The first input may be generated based at least in part on the generated internal voltage and an external voltage. Further, the second input may be generated based at least in part on a voltage drop of the loading circuit.

### BRIEF DESCRIPTION OF THE DRAWINGS

The above and other features and advantages of the invention will become more apparent to those of ordinary skill in the art by describing in detail exemplary embodiments thereof with reference to the attached drawings, in which:

FIG. 1 illustrates a circuit diagram of an internal voltage generating circuit according to an embodiment of the invention; and

FIG. 2 illustrates a circuit diagram of internal voltage generating circuit according to another embodiment of the invention.

### DETAILED DESCRIPTION OF THE INVENTION

Korean Patent Applications 10-2007-0028472 filed on Mar. 23, 2007, in the Korean Intellectual Property Office, and entitled: “Internal Voltage Generating Circuit for Use in Semiconductor Device,” is incorporated by reference herein in its entirety.

The present invention will now be described more fully hereinafter with reference to the accompanying drawings, in which exemplary embodiments of the invention are illustrated. The invention may, however, be embodied in different forms and should not be construed as being limited to the embodiments set forth herein. Rather, these embodiments are provided so that this disclosure will be thorough and complete, and will fully convey the scope of the invention to those skilled in the art.

In the drawing figures, dimensions may be exaggerated for clarity of illustration. Furthermore, like reference numerals refer to like elements throughout.

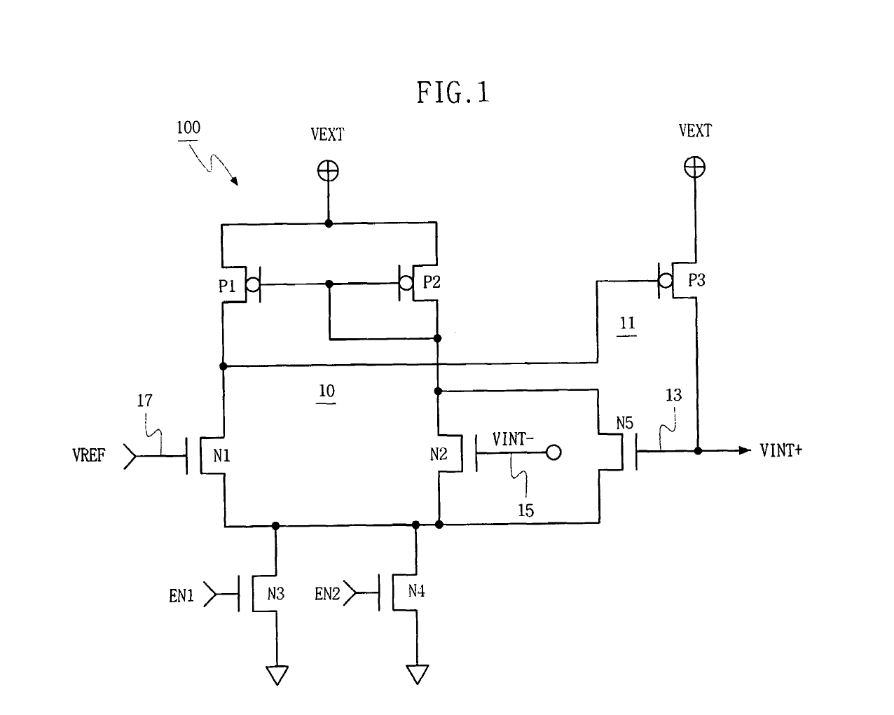

In FIG. 1, the internal voltage generating circuit 100 may include a comparison unit 10. The comparison unit 10 may operate as a comparator and may be a current mirror type differential amplifier in at least one embodiment. The comparison unit 10 may include a reference voltage input terminal 17 to receive a reference voltage VREF and a driving unit 11 receives an output internal voltage from the comparison unit 10. Internal voltage generating circuit 100 further includes a feedback input terminal 13 to receive a first internal voltage VINT+ from driving unit 11. The comparison unit 10 may utilize an external voltage VEXT as an operating voltage in order to generate and to output an internal voltage. Further, the output internal voltage of comparison unit 10 may be responsive to a voltage level of the reference voltage VREF.

The internal voltage generating circuit 100 may further include a driving unit 11 to drive an external voltage VEXT according to the output internal voltage received from comparison unit 10. The driving unit 11 may further provide a first internal voltage VINT+ to the comparison unit 10 via the feedback input terminal 13. The internal voltage generating circuit 100 may further include a sub feedback input unit 15 to provide a second internal voltage VINT− to the comparison unit 10. The sub feedback input unit 15 may provide second internal voltage VINT− to the comparison unit 10, and may provide the second internal voltage VINT− in parallel with the first internal voltage VINT+ from driving unit 11, although the scope of the present invention is not so limited. The first internal voltage VINT+ provided from driving unit 11 may be a voltage output from a PMOS transistor (see below) in response to receiving the output internal voltage from comparison unit 10 and an external voltage VEXT. The second internal voltage VINT− provided to the sub feedback input unit 15 may be a voltage output from a loading circuit (not shown) of the internal voltage generating circuit 100. A voltage level of the second internal voltage VINT− may be lower than a voltage level of first internal voltage VINT+, due at least in part to a configuration of the loading circuit, for example.

Continuing with this embodiment, the comparison unit 10 may include first and second PMOS transistors P1 and P2. The first and second PMOS transistors P1 and P2 may each have a source terminal and a gate terminal. The source terminals of PMOS transistors P1 and P2 may be coupled in common to a node adapted to receive an external voltage VEXT. Furthermore, the gate terminals of PMOS transistors P1 and P2 may be coupled to one another. The comparison unit 10 may further include a first NMOS transistor N1, a third NMOS transistor N3, a fourth NMOS transistor N4 and a fifth NMOS transistor N5. The first NMOS transistor N1 may include a drain terminal and a gate terminal. The drain terminal of the first NMOS transistor N1 may be coupled to a drain terminal of the first PMOS transistor P1. The gate terminal of the first NMOS transistor N1 may receive a reference voltage VREF from reference voltage input terminal 17. The fifth NMOS transistor N5 may include a source terminal and a drain terminal. The source terminal may be coupled to a source terminal of the first NMOS transistor N1. The drain terminal may be coupled to drain and gate terminals of the second PMOS transistors P2. The gate terminal of second NMOS transistor N5 may receive a first internal voltage VINT+ from feedback input terminal 13. The third NMOS transistor N3 may include a gate terminal and a drain-source channel. The drain-source channel may be connected between the source terminals of the first and second NMOS transistors N1 and N5 and a ground terminal. The gate terminal may be adapted to receive an operation enable signal EN1.

The fourth NMOS transistor N4 may be configured in parallel with respect to the third NMOS transistor N3 and may, in operation, improve one or more drive characteristic of the internal voltage generating circuit 100. The driving unit 11 may include a drive PMOS transistor P3 having a source terminal, a drain terminal and a gate terminal. The source terminal may receive an external voltage VEXT from an external voltage node, and the gate terminal may be coupled to a drain terminal of the first NMOS transistor N1. The drain terminal may be coupled to a gate terminal of the fifth NMOS transistor N5 and may output the first internal voltage VINT+.

The sub feedback input unit 15 may include a second NMOS transistor N2 having a source terminal, a drain terminal and a gate terminal. The drain terminal may be coupled to a drain terminal of the fifth NMOS transistor N5. The source terminal may be coupled to a source terminal of the fifth NMOS transistor N5. The gate terminal may be adapted to receive the second internal voltage VINT− which, again, may be a voltage at a different voltage level than the first internal voltage VINT+.

In operation, in the comparison unit 10 illustrated in FIG. 1, a single reference voltage VREF may be applied to the gate terminal of the NMOS transistor N1. First or second internal voltage VINT+, VINT− may be fed back to gate terminals of the NMOS transistor N5 via feedback input terminal 13 and NMOS transistor N2 via sub feedback unit 15, respectively. If at least one of the NMOS transistors N3 and N4 is turned on, the internal voltage generating circuit may compare the reference voltage VREF with first and second internal voltages VINT+ and VINT−. In response to the comparing, the internal voltage generating circuit 100 may generate another internal voltage and output the internal voltage with a voltage level based at least in part on the reference voltage VREF.

The internal voltage generating circuit 100 of FIG. 1 may improve response characteristics of an internal voltage to voltage level changes in the internal voltage. For example, internal voltages with minutely different voltage levels may be fed back from plural locations to comparison unit 10. First and second internal voltages VINT+ and VINT− may be obtained from different locations and applied to the internal voltage generating circuit 100, and the second internal voltage VINT− may have a relatively low voltage level as compared with the first internal voltage VINT+. This may be due at least in part to the second internal voltage VINT− being a voltage applied from circuitry such as a loading circuit that may be located comparatively distant from the internal voltage generating circuit 100. Consequently, the first internal voltage VINT+ may have a voltage level more approximate to a voltage level of reference voltage VREF as compared to the second internal voltage VINT−. Furthermore, in one embodiment, the NMOS transistors N1, N2 and N5 may be the same size. Alternatively, the size of NMOS transistors N2 and N5 in combination may correspond to the size of the NMOS transistor N1.

An operation of the internal voltage generating circuit will now be described in detail. If one of the enable control signals EN1 and EN2 is applied having a high voltage level, a comparison operation of the comparison unit 10 may initiate. In one embodiment, the comparison unit operation may be based on the operation of a current mirror type differential amplifier. For example, when a voltage level of first internal voltage VINT+ is lower than a voltage level of reference voltage VREF as a result of a change in load, NMOS transistor N1 may be turned on at a voltage level greater than NMOS transistor N5. Then, an amount of current sent to a ground through a drain-source channel of NMOS transistor N1 may be increased, thus gradually lowering a drain voltage of the NMOS transistor N1 to a ground level. Subsequently, PMOS transistor P3 may be turned on and thereby increase a voltage level of the first internal voltage VINT+. If the voltage level of the first internal voltage VINT+ is higher than a voltage level of the reference voltage VREF, the NMOS transistor N5 may be turned on and may result in lowering a gate voltage of the PMOS transistors P1 and P2. Drain voltage of the NMOS transistor N1 may approach a voltage level of the external voltage VEXT. PMOS transistor P3 may be turned off, which may prevent a voltage level increase in the first internal voltage VINT+. In addition, the NMOS transistor N2 that receives second output internal voltage VINT− may operate in parallel with the NMOS transistor N5 such that the comparator has two feedback inputs. In an embodiment in accordance with FIG. 1, response characteristics of the circuit may be improved such that an immediate or substantially immediate voltage compensation from a load change may be implemented.

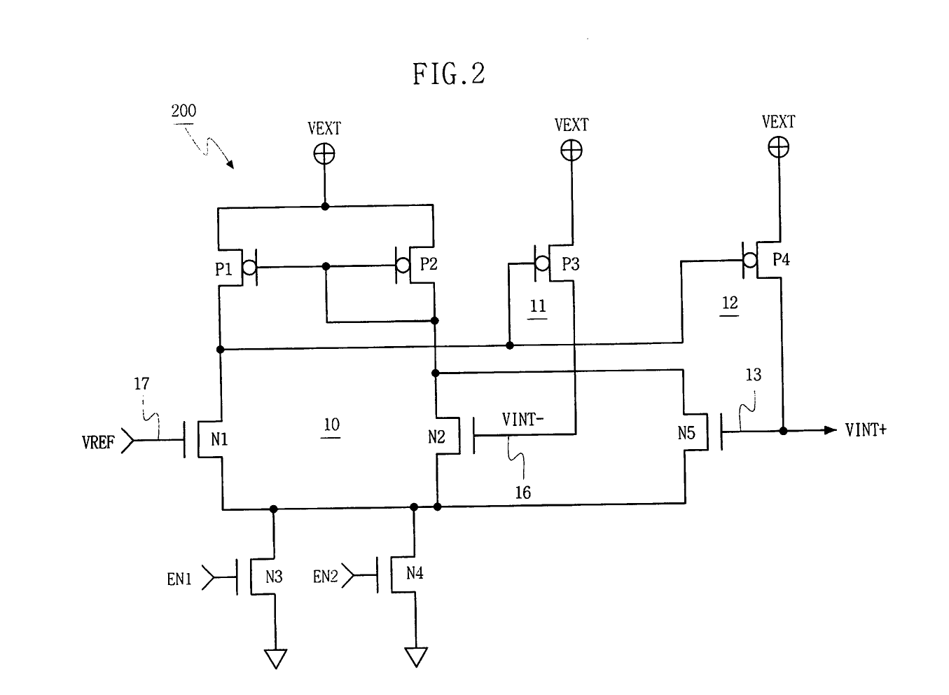

Referring now to FIG. 2, the internal voltage generating circuit 200 includes a comparison unit 10, a driving unit 11, a driving unit 12, and a sub feedback input unit 16. The comparison unit 10 includes first and second PMOS transistors P1 and P2, and first, third, fourth and fifth NMOS transistor N1, N3, N4 and N5. Sub feedback unit 16 includes second NMOS transistor N2. Driving unit 11 includes third PMOS transistor P3, and driving unit 12 includes fourth PMOS transistor P4.

In the first and second PMOS transistors P1 and P2, source terminals may be coupled in common to an external voltage source to receive an external voltage VEXT, and gate terminals may be coupled to one another. In the first NMOS transistor N1, a drain terminal may be coupled to a drain terminal of the first PMOS transistor P1, and a gate terminal of the first NMOS transistor N1 may receive a reference voltage VREF from reference voltage input terminal 17. In the fifth NMOS transistor N5, a source terminal may be coupled to a source terminal of the first NMOS transistor N1, and a drain terminal may be coupled to drain and gate terminal of the second PMOS transistor P2. The gate terminal of fifth NMOS transistor N5 may receive a first internal voltage VINT+ from feedback input terminal 13.

In the third NMOS transistor N3, a drain-source channel may be connected between the source terminals of the first and second NMOS transistors N1 and N2 and a ground terminal, and a gate terminal may receive an operation enable signal EN1. The third PMOS transistor P3 and the second PMOS transistor P4 of driving unit 11 and driving unit 12, respectively, may comprise a first and a second drive PMOS transistor, respectively. In the second drive PMOS transistor P4, a source terminal may receive an external voltage VEXT, a gate terminal may be coupled to a drain terminal of the first NMOS transistor N1, and a drain terminal may be coupled to a gate terminal of the fifth NMOS transistor N5, which may output the first internal voltage VINT+.

In the first drive PMOS transistor P3, a source terminal may receive an external voltage VEXT, and a gate terminal may be coupled to a drain terminal of the first NMOS transistor N1 and may be adapted to output a second internal voltage VINT− different from a voltage level of the first internal voltage VINT+ to a drain terminal of NMOS transistor N2.

In the second NMOS transistor N2 of sub feedback unit 16, a drain terminal may be coupled to a drain terminal of the fifth NMOS transistor N5, and a source terminal may be coupled to a source terminal of the fifth NMOS transistor N5 and may be adapted to receive the second internal voltage VINT− through a gate terminal thereof. The embodiment as described above and as illustrated in FIG. 2 may vary from the embodiment illustrated in FIG. 1 in that the first drive PMOS transistor P3 may have a drain terminal coupled to a gate terminal of the second NMOS transistor N2. In this configuration, a plurality of internal voltages may be fed back in parallel and compared to a reference voltage VREF to produce an internal voltage.

In such a voltage generating circuit having a multi feedback input and a voltage control method as described above with reference to FIGS. 1 and 2, a more stabilized circuit operation may be reliably obtained. In addition, high speed response characteristics to a load change of internal voltage may result and thereby increase the reliability in semiconductor memory devices.

It will be apparent to those skilled in the art that modifications and variations can be made in the present invention without deviating from the spirit or scope of the invention. Thus, it is intended that the present invention cover any such modifications and variations of this invention provided they come within the scope of the appended claims and their equivalents. For example, the number of NMOS transistors providing additional feedback inputs may increase, or the size of transistor may be appropriately controlled or changed diversely. Accordingly, these and other changes and modifications are seen to be within the true spirit and scope of the invention as defined by the appended claims.

Exemplary embodiments of the present invention have been disclosed herein, and although specific terms are employed, they are be interpreted in a generic and descriptive sense only and not for purpose of limitation. Accordingly, it will be understood by those of ordinary skill in the art that various changes in form and details may be made without departing from the spirit and scope of the present invention as set forth in the following claims.

What is claimed is:

1. An internal voltage generating circuit, comprising:
a reference voltage input terminal to receive a reference voltage;
a comparison unit to output a first internal voltage, the first internal voltage having a voltage level based at least in part on the reference voltage;
a first feedback unit to receive the first internal voltage and an external voltage and to provide a first feedback internal voltage to the comparison unit;
a loading circuit to output a second internal voltage; and
a second feedback unit to receive the second internal voltage from the loading circuit and to provide a second feedback internal voltage to the comparison unit.

2. The internal voltage generating circuit as claimed in claim 1, wherein the comparison unit is further adapted to generate another first internal voltage based at least in part on a comparison of the first feedback internal voltage and the second feedback internal voltage.

3. The internal voltage generating circuit as claimed in claim 1, wherein the comparison unit is a current mirror type differential amplifier.

4. The internal voltage generating circuit as claimed in claim 1, wherein the first feedback internal voltage and the second feedback internal voltage are provided to the comparison unit in parallel.

5. The internal voltage generating circuit as claimed in claim 1, wherein the first feedback unit comprises a driving unit to receive the external voltage, to drive the external voltage according to the first internal voltage provided from the comparison unit, and to provide a feedback to the feedback input terminal.

6. The internal voltage generating circuit as claimed in claim 1, wherein first feedback internal voltage has a voltage level higher than the second feedback internal voltage.

7. The internal voltage generating circuit as claimed in claim 3, wherein the current mirror type differential amplifier is configured to operate as a comparator.

8. An internal voltage generating circuit, comprising:
a reference voltage input terminal to receive a reference voltage;
a comparison unit to output an internal voltage, the internal voltage having a voltage level based at least in part on the reference voltage;
a first feedback unit to receive the internal voltage and an external voltage and to provide a first feedback internal voltage to the comparison unit; and
a second feedback unit to receive the internal voltage and an external voltage and to provide a second feedback internal voltage to the comparison unit.

9. The internal voltage generating circuit as claimed in claim 8, wherein the comparison unit is further adapted to generate another internal voltage based at least in part on a comparison of the first feedback internal voltage and the second feedback internal voltage.

10. The internal voltage generating circuit as claimed in claim 8, wherein the comparison unit is a current mirror type differential amplifier.

11. The internal voltage generating circuit as claimed in claim 8, wherein the first feedback internal voltage and the second feedback internal voltage are provided to the comparison unit in parallel.

12. The internal voltage generating circuit as claimed in claim 8, wherein the first feedback unit and the second feedback unit each comprise a driving unit to receive the external voltage, to drive the external voltage according to the internal voltage provided from the comparison unit, and to provide a feedback to the feedback input terminal.

13. The internal voltage generating circuit as claimed in claim 10, wherein the current mirror type differential amplifier is configured to operate as a comparator.

14. A method of generating an internal voltage, comprising:
generating an internal voltage based at least in part on a reference voltage;
providing the internal voltage to a feedback input unit and to a loading circuit;
receiving a plurality of voltage feedback inputs based at least in part on the provided internal voltage; and
adjusting the generated internal voltage based at least in part on the plurality of voltage feedback inputs.

15. The method of generating an internal voltage as claimed in claim 14, further comprising:
receiving the plurality of voltage feedback inputs at approximately the same time.

16. The method of generating an internal voltage as claimed in claim 14, wherein the plurality of feedback inputs comprise a first and a second feedback input provided from the feedback input unit and from the loading circuit, respectively.

17. The method of generating an internal voltage as claimed in claim 16, wherein the first input is generated based at least in part on the generated internal voltage and an external voltage.

18. The method of generating an internal voltage as claimed in claim 16, wherein the second input is generated based at least in part on a voltage drop of the loading circuit.
